(19) United States
(12) Patent Application Publication
(10) Pub. No.: US 2015/0291078 A1
(43) Pub. Date: Oct. 15, 2015

(54) WHEELBARROW COVER

(71) Applicant: REMOVERITE INCORPORATED, Los Angeles, CA (US)

(72) Inventor: Hector Carrillo, JR., Los Angeles, CA (US)

(73) Assignee: REMOVERITE INCORPORATED, Los Angeles, CA (US)

(21) Appl. No.: 14/251,770

(22) Filed: Apr. 14, 2014

(51) Int. Cl. B60P 7/02; B60P 3/42; B62B 1/20

(52) U.S. Cl. CPC B60P 7/02; B62B 1/20; B60P 3/426

(57) ABSTRACT

A cover for a wheelbarrow having a central region with a frame extending outwardly therefrom. A flexible gasket is provided on an interior surface of the frame and contacts the wheelbarrow's rim when the cover is set in place. Securement assemblies are engaged to lock the cover to the wheelbarrow and this deforms the gasket, thus providing a watertight seal between the cover and wheelbarrow. A hole is defined in the central region of the cover and a tubular member extends therethrough. A detachable cap is engaged with the tubular member to selectively close off access to the interior cavity of the wheelbarrow. A tether keeps the cap engaged with the cover. The cap may be removed to allow a pipe to be inserted into the interior cavity to pump liquid into or out of the wheelbarrow.

### BACKGROUND OF THE INVENTION

1. Technical Field

This invention relates generally to construction and landscaping equipment. More particularly, this invention is directed to wheelbarrows. Specifically, this invention is directed to a cover for a wheelbarrow which includes a deformable flexible gasket on an underside of the cover to provide a watertight seal between the cover and the wheelbarrow, a drainage access defined in the cover which is closeable by way of a cap that is tethered to the cover; and one or more securement assemblies for locking the cover to the wheelbarrow.

2. Background Information

Every day, thousands of times, across the country there exists a potential for spilling dangerous chemicals onto the ground or onto surfaces such as the street. These chemicals can seep into the ground or make their way into the gutters and sewers and ultimately into groundwater, contaminating the same.

A particularly problematic situation exists surrounding concrete pumps or concrete trucks. It is common and necessary for pumps or trucks to wash out their hoses or chutes to clear residual concrete from the same. If this is not done then the concrete will harden, rending the hose or chute useless. Typically, the hoses or chutes are discharged into a wheelbarrow which is then pushed to a suitable location for disposal of the wastewater/concrete mixture. Since this mixture includes a lot of water it is common that some spillage over the sides of the wheelbarrow will occur. Because of the sheer number of concrete trucks and pumps that are in operation across the country, this spillage can result in the contamination of a lot of groundwater. The problem is of a sufficient scope that cities have started imposing fines for this type of spillage. Los Angeles, for example, imposes a fine of $10,000 for spilling such contaminated water on the ground. Obviously, this poses a problem for concrete pump and truck operators.

In the past, contractors have tried to control spillage by a variety of means, including holding pieces of plywood against the top of wheelbarrows to stop the chemical-laden water from slopping over the sides. This has, as one expects, been of very limited effectiveness, particularly when the wheelbarrow has to be moved over uneven ground.

Several patents have been directed to addressing this type of problem.

GB2449697 (Victory) discloses a flexible bladder that is shaped and sized to fit within a standard wheelbarrow interior. The bladder is a self-contained unit that can be filled with fresh water or grey water (such as from a bathtub). The bladder includes an inlet through which the water is introduced into the bladder. A stopper or cap may be provided to close the inlet. The bladder also includes an outlet which allows the contents to drain from within the bladder. The wheelbarrow may be tipped to allow the water to flow out of the outlet or a pipe may be hooked up to the outlet to allow the water to drain therefrom. While this type of system works adequately with fresh water or grey water it would not be very useful for a situation such as cleaning out a hose or discharge chute of a concrete truck. This is because any suspended particulate material within the wastewater from the concrete pump or truck would become deposited within the bladder and would not be easily removed therefrom without some effort and additional water.

US publication number 2011/0139038 (Pipkorn et al) discloses a cover for a wheelbarrow. The cover is fabricated from a rigid material and is snap-fitted onto the edges of the wheelbarrow walls. The cover is particularly useful when the wheelbarrow is transporting a concrete slurry and the cover is used to prevent that slurry from drying out and starting to set. While the cover will stop the concrete mixture from slopping over the sides of the wheelbarrow, it is less suitable for use when a water mixture is being transported in the wheelbarrow. This is because the cover includes only a small aperture defined in the edge and through which an object, such as a shovel handle can project. When transporting water, this aperture will still some of the liquid from the interior to spill over the associated side of the wheelbarrow, even though on a much reduced scale than if the cover was not present. When the area is reached where the wastewater is to actually be dumped, the entire cover has to be removed as the small aperture is completely insufficient for training the wheelbarrow.

DE20308423 (emano Kunstofftechnik GmbH) discloses a transport container, especially for water, and this container is sized to fit within the interior of a wheelbarrow. This container is again a thin-walled bladder that would exhibit the same problems as the bladder of the '497 patent referenced above.

SE461640 (Hammarstroem) discloses an insulated wheelbarrow that includes a cover which engages the rim 11 of the wheelbarrow. There is no disclosure of any type of connector to secure the cover to the rim. Additionally, the cover would have to be entirely removed in order to fill the wheelbarrow or remove the contents of the wheelbarrow.

A range of other wheelbarrow covers are known. For instance, U.S. Pat. No. 1,198,264 discloses a wheelbarrow useful for mixing concrete. The wheelbarrow body comprises a drum that is rotatable within a frame using a crank-handle. Because the drum is rotatable, it includes a slide or lid which fits guiding members provided on either side of an opening to the drum interior. The slide or lid is movable to close off access to that opening. The type of slide or lid is not disclosed in any detail. However, since the drum is to be rotated in such a manner that the contents will periodically contact the slide or lid, this component will have to be secured to the wheelbarrow walls or frame in such a way that the lid will not pop off or leak when the concrete mixture falls onto the same.

U.S. Pat. No. 6,547,309 (Franklin) discloses a cover for a wheelbarrow that is provided to stop the contents of the wheelbarrow from falling out of the same. The cover is a flexible grate-like panel that extends from one side wall to the other. The panel does not extend from the front of the wheelbarrow to the back. This cover therefore would not be suitable for preventing a liquid slurry from spilling out of the wheelbarrow's interior.

U.S. Pat. No. 8,517,402 (Davis) discloses a system that secures to a portion of a upper rim 11 of a wheelbarrow. A bag is retained by this support system in such a manner that the bag is positioned within part of the interior of the wheelbarrow. A cover is provided for the bag. Yard waste and the like may be placed in the bag and the cover used to prevent that yard waste from dropping out of the same. The bag does not fill the entire interior of the wheelbarrow and the cover does not extend over the entire interior thereof. While a liquid could be carried within the bag this would make transportation unnecessarily complex. Additionally, the angle of the support system would likely lead to spillage of the contents when the wheelbarrow is moved over uneven ground.

Both of US publication 2005/0212238 (Conley) and U.S. Pat. No. 7,562,898 (Hand et al) disclose worktable assemblies which rest on the upper rim 11 of a wheelbarrow. While Conley does disclose a method of securing this worktable to the rim 11 of the wheelbarrow, the table extends for a distance outwardly beyond the side and front walls of the wheelbarrow. This would make transporting anything in the wheelbarrow difficult, particularly on a construction site. It would also be cumbersome to have to repeatedly disengage the worktable from the wheelbarrow in order to tip out the contents of the wheelbarrow for disposal. Additionally, Conley's worktable defines a large central aperture therein. This would make spillage of liquid contents in the wheelbarrow quite likely. Hand et al discloses a worktable that has storage compartments which extend into the interior of the wheelbarrow. Obviously, this set-up would substantially affect the load that could be carried by the wheelbarrow. Additionally, the waste-water or concrete slurry would tend to accumulate in the compartments beneath the worktable and this too would be an undesirable situation.

U.S. Publication 2012/0181761 (Skijus et al) discloses a flexible sheet-like cover that is wound onto a roll assembly that is secured to the rim 11 of a side wall of the wheelbarrow. The cover is pulled over the top of a load and is secured to the other side wall of the wheelbarrow. While this flexible cover is suitable for preventing yard waste and the like from dropping out of the wheelbarrow's interior, this cover would not be adequate for preventing spillage of a liquid from the wheelbarrow. The cover does not extend from the front end of the wheelbarrow to the rear end thereof and wastewater could therefore spill over the front or rear ends of the wheelbarrow.

There is still a need in the art for an improved cover for a wheelbarrow that is useful for transporting liquids or slurries and reducing spillage of the same from the wheelbarrow's interior.

### SUMMARY

A cover for a wheelbarrow having a flexible gasket provided on an interior surface and the gasket contacts the wheelbarrow's rim when the cover is set in place. Securement assemblies are engaged to lock the cover to the wheelbarrow and this deforms the gasket, thus providing a watertight seal between the cover and wheelbarrow. The cover includes a central region and a frame extending outwardly therefrom. A hole is defined in the central region of the cover and a tubular member extends therethrough. A detachable cap is engaged with the tubular member to selectively close off access to the interior cavity of the wheelbarrow. A tether keeps the cap engaged with the cover. The cap may be removed to allow a pipe to be inserted into the interior cavity to pump liquid into or out of the wheelbarrow.

In one aspect, the invention may provide a cover for a wheelbarrow, where the wheelbarrow has a peripheral wall which bounds and defines an interior cavity for carrying a load, and wherein an upper edge of the peripheral wall forms a rim; and wherein said cover comprises:
a central region having an interior surface and an exterior surface;
a frame circumscribing the central region;
a gasket provided on an interior surface of the frame; said gasket being adapted to be positioned adjacent the rim of the wheelbarrow when the cover is used to close off access to the interior cavity of the wheelbarrow.

In another aspect, the invention may provide a wheelbarrow and cover in combination; wherein the wheelbarrow has a peripheral wall which bounds and defines an interior cavity for carrying a load, and an upper edge of the peripheral wall forms a rim; and
the cover is selectively engageable with the wheelbarrow to prevent access to the interior cavity; wherein said cover comprises:
a central region having an interior surface and an exterior surface;
a frame circumscribing the central region;
a gasket provided on an interior surface of the frame; said gasket being positioned adjacent the rim of the wheelbarrow when the cover is selectively engaged with the wheelbarrow.

The invention may further provide a securement assembly adapted to secure the cover to the wheelbarrow; wherein the securement assembly is movable between an engaged position and a disengaged position; and when in the engaged position the securement assembly locks the cover to the wheelbarrow; and when the securement assembly is in the disengaged position, the cover is not locked to the wheelbarrow.

The invention may further provide a hole defined in the central region of the cover;
a tubular member engaged in the hole and defining a bore therein; and
a cap detachably engaged with the tubular member to selectively block access to the bore.

Still further, the invention may provide a tether extending between a portion of the cover and the cap.

### BRIEF DESCRIPTION OF THE SEVERAL VIEWS OF THE DRAWINGS

A sample embodiment of the invention, illustrative of the best mode in which Applicant contemplates applying the principles, is set forth in the following description, is shown in the drawings and is particularly and distinctly pointed out and set forth in the appended claims.

FIG. 1 is a perspective view of a wheelbarrow and a cover in accordance with an aspect of the present invention;

FIG. 2 is a top view thereof;

FIG. 3 is a right side view thereof;

FIG. 4 is an exploded perspective view of the cover and its relationship to the wheelbarrow;

FIG. 5 shows a top view of a flexible gasket used in the cover;

FIG. 6 shows a perspective view of the gasket;

FIG. 7 is a front end view of the cover;

FIG. 8 is a top view of the cover;

FIG. 9 is a side view of the cover;

FIG. 10 is a bottom view of the cover;

FIG. 11 is a cross-sectional end view of the plumbing drain and screw cap of the cover;

FIG. 12 is an enlarge side view of a clamp assembly used to secure the cover to the rim 11 of the wheelbarrow;

FIG. 13 is a right side view of the wheelbarrow with the cover engaged and carrying a quantity of liquid in the interior; and where the wheelbarrow is in an at-rest position;

FIG. 14 is a right side view of the wheelbarrow and cover of FIG. 13; with the wheelbarrow in a tipped position for movement across a surface; and

FIG. 15 is a perspective view of the wheelbarrow and cover with a flexible pipe from a pump engaged with the drain assembly on the cover.

Similar numbers refer to similar parts throughout the drawings.

### DETAILED DESCRIPTION

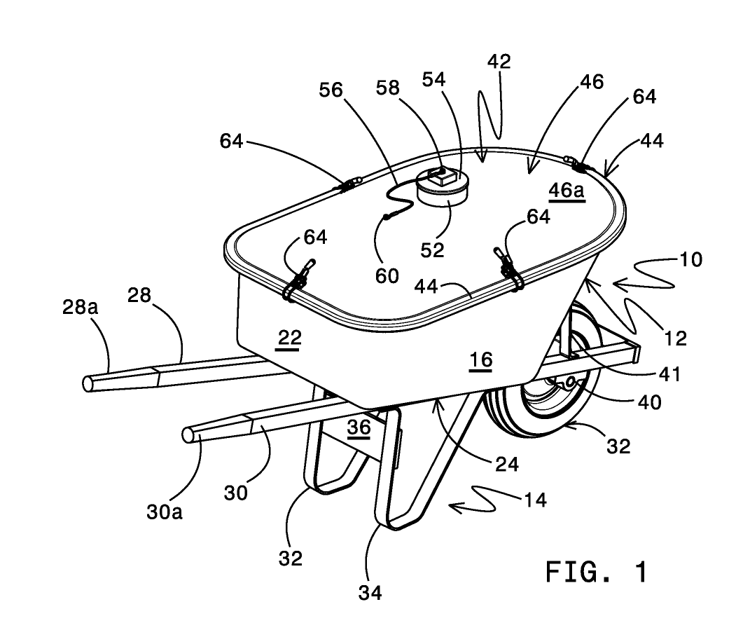

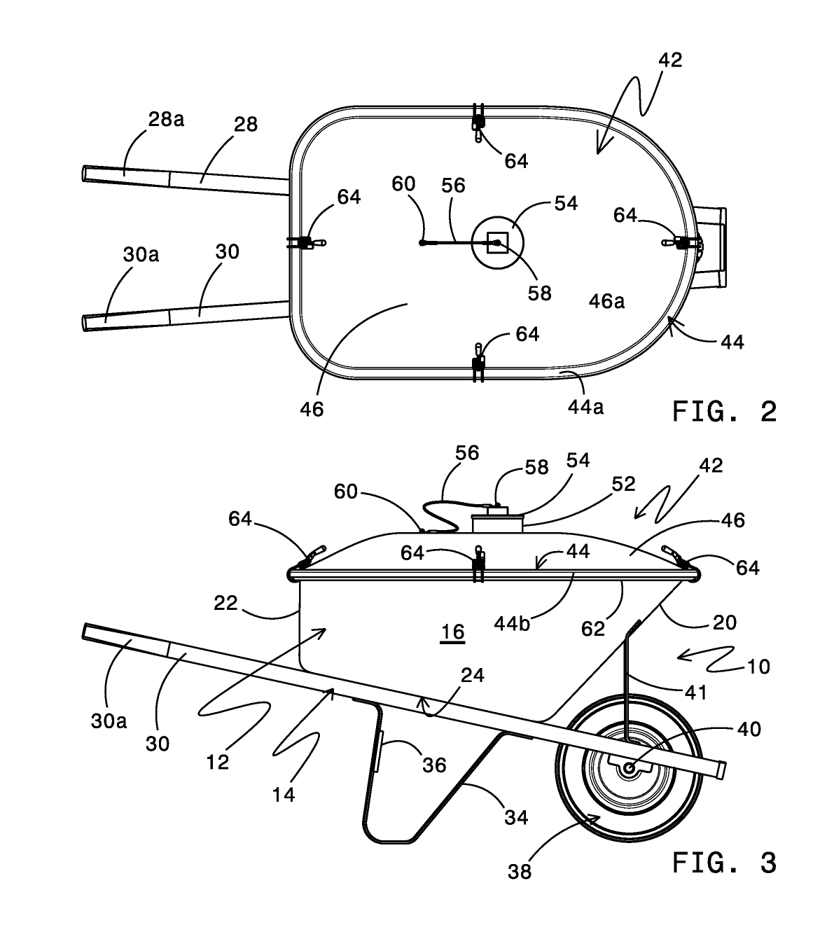

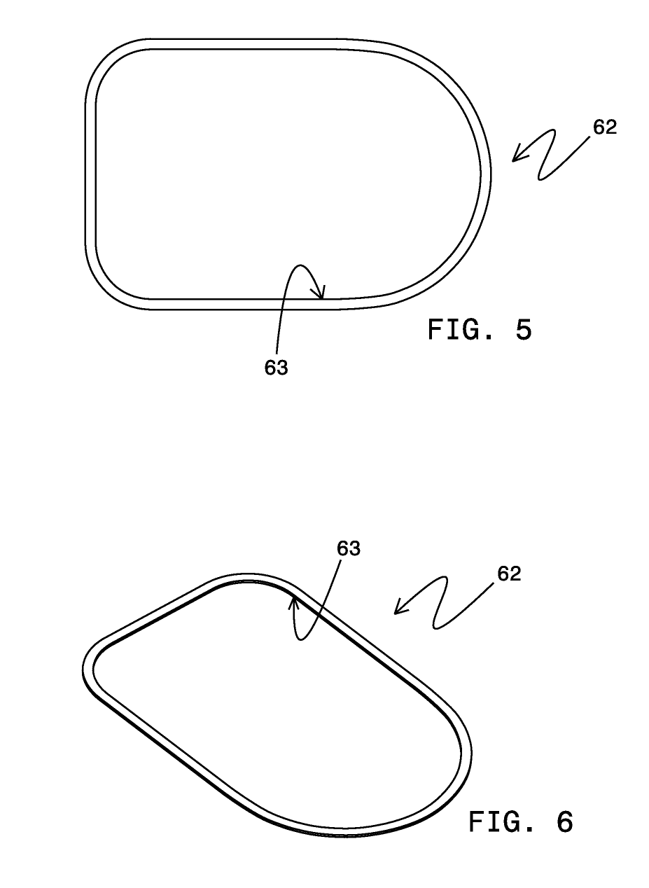

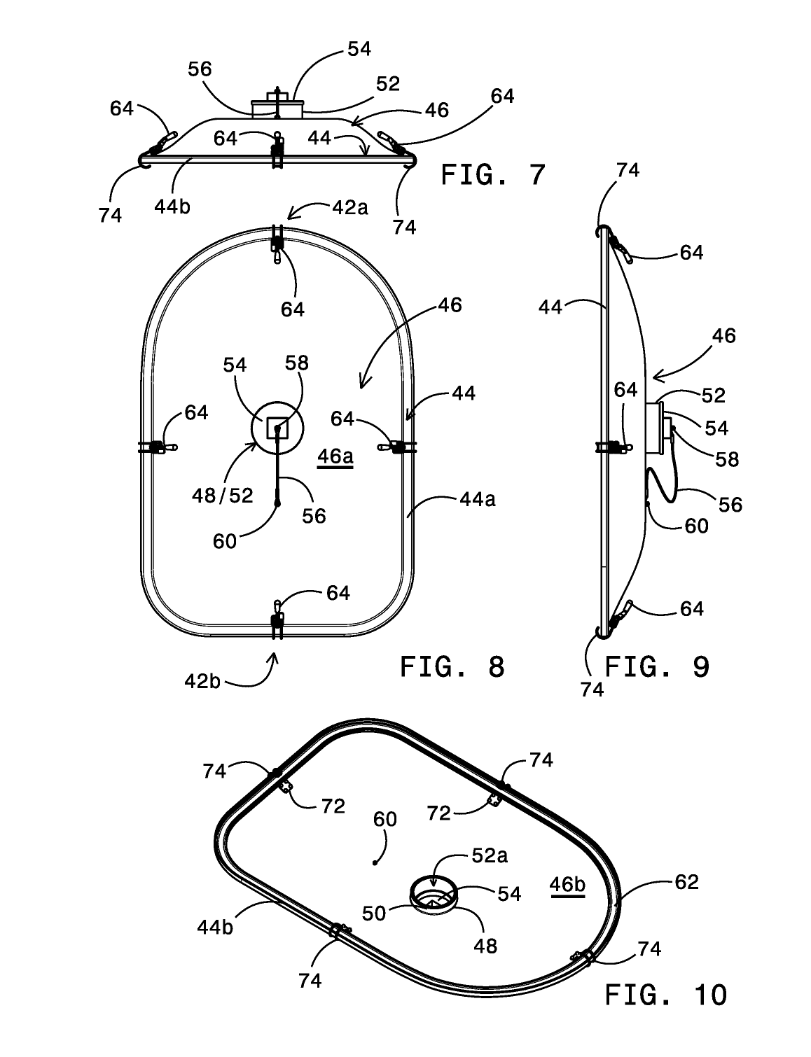

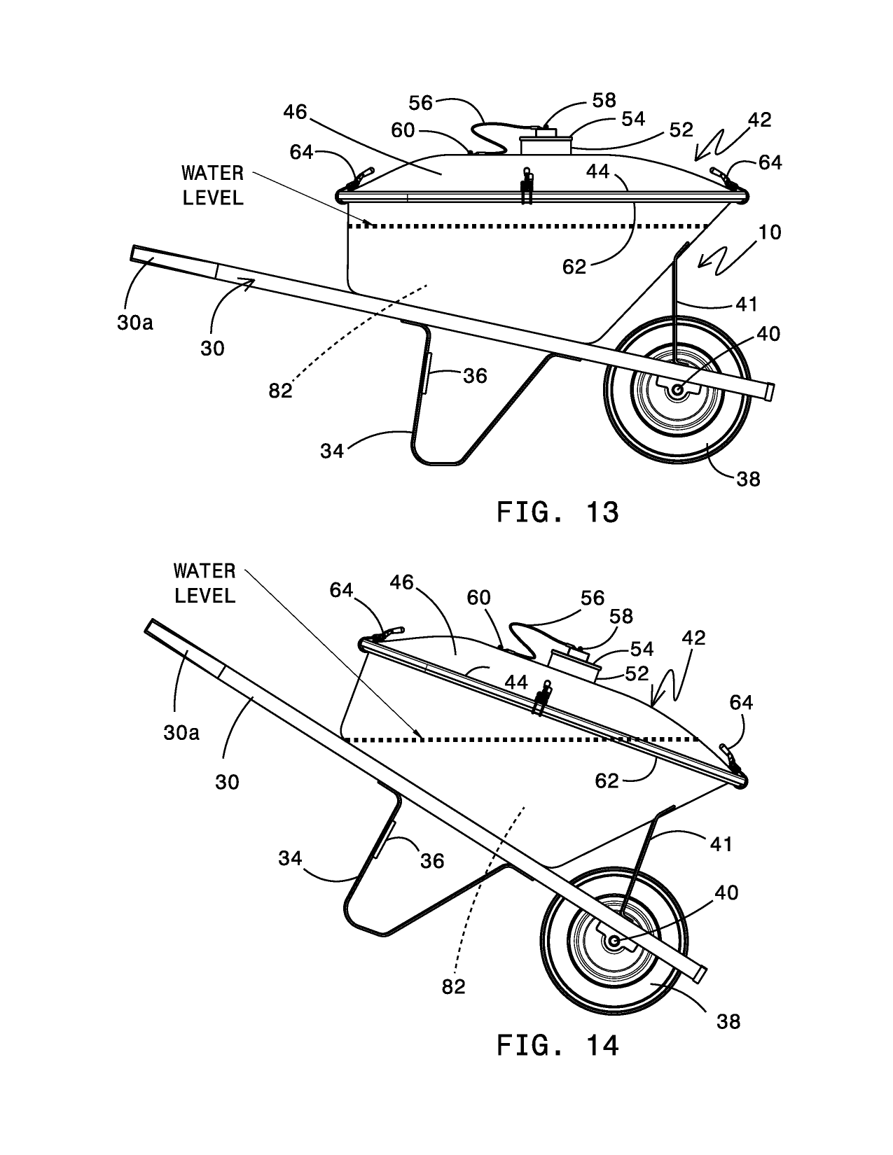

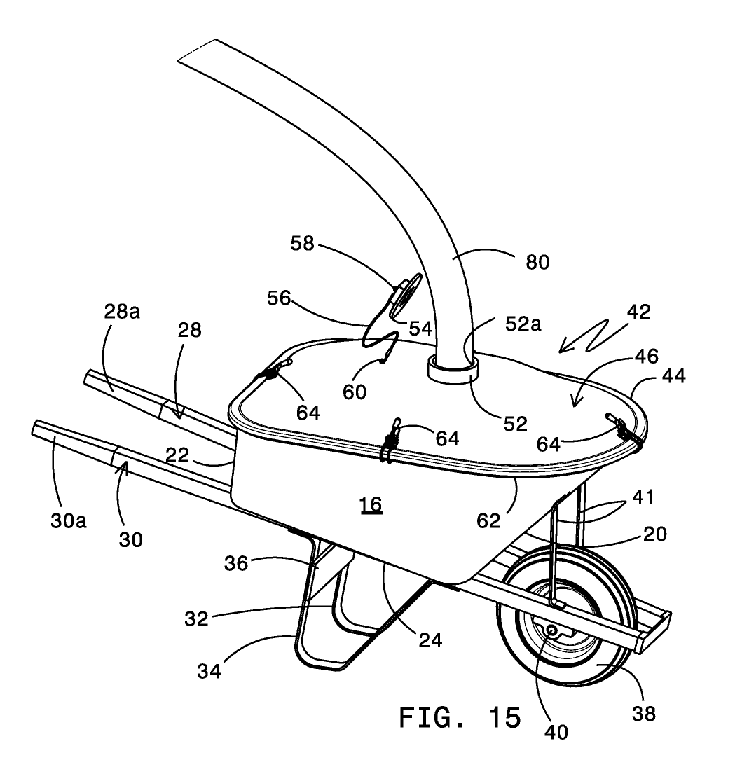

Referring to FIGS. 1-14 there is shown a wheelbarrow 10 having a body 12 which is supported on a frame 14. Body 12 includes a right sidewall 16, a left sidewall 18, a front wall 20, a rear wall 22, and a bottom wall 24. Right and left sidewalls 16, 18, front and rear walls 20, 22 and bottom wall 24 form a peripheral wall 16-24 which bounds and defines an interior cavity 26. An upper edge 16a, 18a, 20a, and 22a of each of the walls 18-22 forms a rim 11 (FIG. 12) which defines an opening to interior cavity 26. Rim 11 may be formed in any one of a number of different cross-sectional shapes. As illustrated herein in FIG. 12, rim 11 preferably is generally circular in cross-section. As is well understood, a load to be carried by wheelbarrow 10 is placed into interior cavity 26 and the load rests on bottom wall 24 and is kept in place by walls 18-22.

Frame 14 includes a tapering, generally U-shaped member which includes a first arm 28 and a second arm 30. A tapered handle grip 28a, 30a preferably is provided on each of the first and second arms 28, 30. Generally V-shaped first and second legs 32, 34 extend outwardly and downwardly from first and second arms 28, 30, respectively. A cross-brace 36 extends between first and second legs 32, 34. A single wheel 38 is mounted via an axle 40 to frame 14. Finally a brace 41 extends upwardly from each of the first and second arms 28, 30 to front wall 20. All of these aforementioned components are part of a standard, known wheelbarrow 10

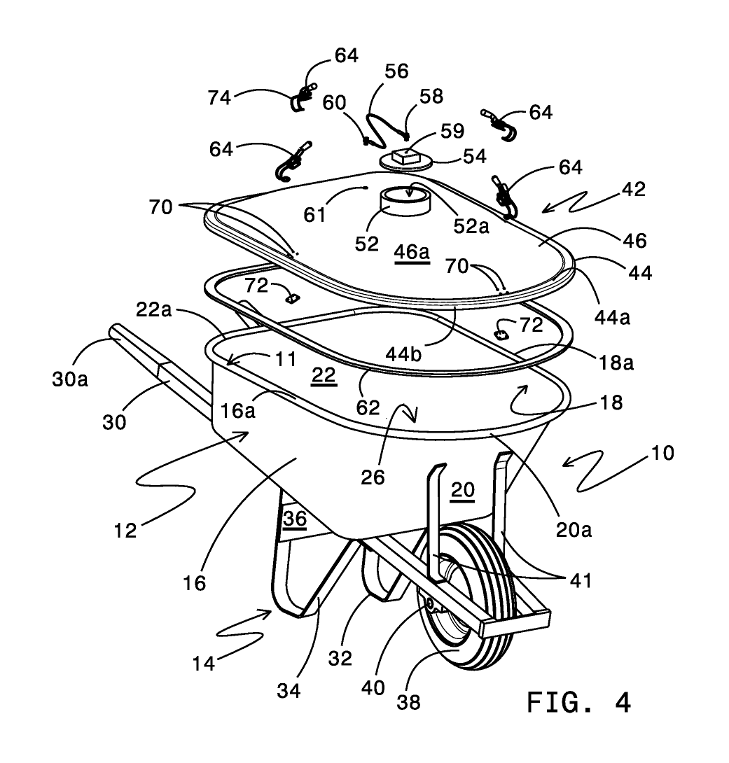

In accordance with an aspect of the present invention, a cover 42 is selectively engageable with wheelbarrow 10. Cover 42 is best seen in FIGS. 4-12. Cover 42 is fabricated from a sheet type material, such as high impact polystyrene (HIPS), which is heated and pushed down onto a mold to give it a truncated-dome shaped illustrated in the figures. Cover 42 preferably is generally C-shaped in cross-section. Cover 42 is molded to form a frame 44 (FIG. 4) which circumscribes a central region 46. Frame 44 is substantially unbroken along its perimeter and thus forms a substantially continuous edge to central region. Central region 46 is integrally formed with frame 44.

As shown in FIG. 12, frame 44 is furthermore substantially continuous with central region 46 and is configured to be generally L-shaped. In particular, frame 44 includes a first leg 44a that is disposed at an angle α relative to the adjacent central region 46. The angle α preferably is an obtuse angle, i.e., greater than ninety degrees. Frame 44 further includes a second leg 44b that is disposed generally at right angles to first leg 44a and extends downwardly therefrom. Thus, second leg 44b of frame 44 forms a small skirt which extends downwardly from central region 46. When cover 42 is placed on wheelbarrow 10, first leg 44a of frame 44 will be disposed adjacent an upper surface of the rim 11 of wheelbarrow 10 and the skirt formed by second leg 44b of frame 44 will be disposed outwardly away from an exterior side surface of the rim 11. This skirt formed by second leg 44b is disposed outwardly from the perimeter of rim 11 and will be separated from the perimeter by a small gap. The skirt will aid in helping cover 42 to be correctly positioned on rim 11 and will prevent cover from sliding laterally off rim 11 when cover 42 is secured thereto, as will be hereinafter described. When cover 42 is placed on wheelbarrow 10, frame 44 circumscribes substantially the entire rim 11 and is substantially uninterrupted. In other words, the frame 44 is free of slots or gaps.

When cover 42 is engaged on rim 11 of wheelbarrow, substantially no part of cover 42 extends downwardly into the interior cavity defined by the wheelbarrow's peripheral wall 16-24.

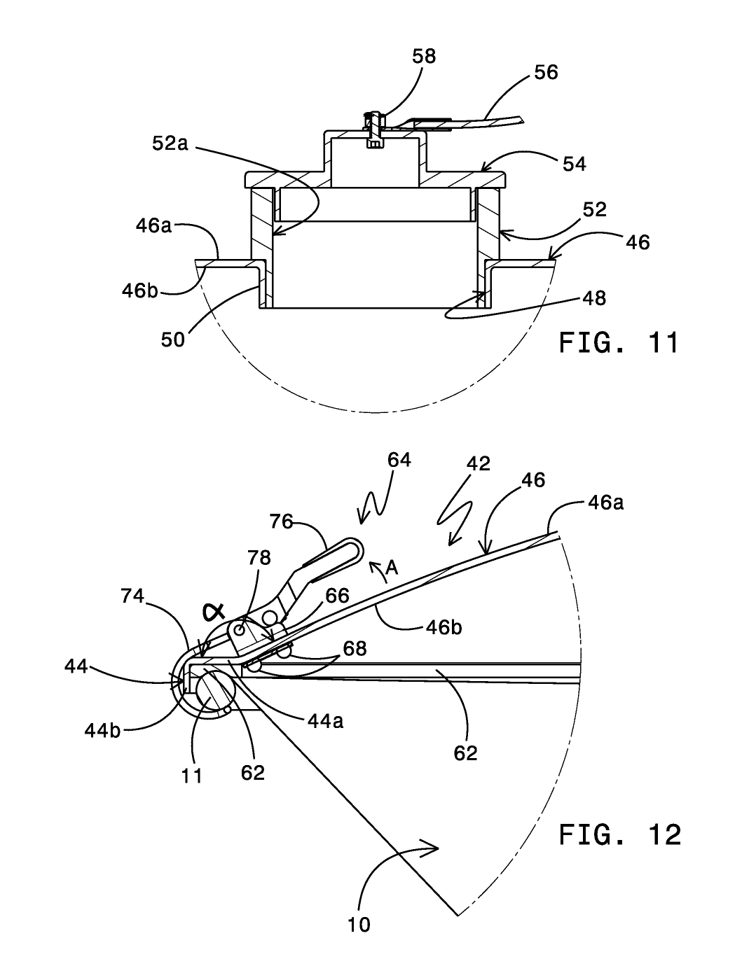

Central region 46 of cover 42 has an exterior surface 46a and an interior surface 46b (FIG. 10). An aperture 48 (FIG. 11) is defined in central region 46 and aperture 48 extends from exterior surface 46a through to interior surface 46b. Aperture 48 may be positioned anywhere on central region 46 but, preferably, aperture 48 is generally centrally located as is best seen in FIG. 8. An annular flange 50 (FIG. 11) bounds and defines aperture 48 and the flange extends downwardly for a distance below interior surface 46b. A first region of a tubular member 52 is received through aperture 48 and a second region of tubular member 52 extends upwardly beyond exterior surface 46a of central region 46. The first region of tubular member 52 is fixedly secured to flange 50 by a suitable means. For example, tubular member 52 may be secured to flange 50 by heat welding or by an adhesive. Tubular member 52 defines a bore 52a therein. A removable screw-in cap 54 is secured to one of central region 46 or frame 44 of cover 42 by a tether 56. (Mating threads (not shown) are provided on tubular member 52 and cap 54). A first end of tether 56 is secured to cap 54 in a suitable manner, such as by way of a fastener 58 which is inserted through a hole 59 (FIG. 4) defined in cap 54. A second end of tether 56 is secured to central region 46 (or frame 44) by a second fastener 60 which is inserted through a hole 61 (FIG. 4) defined in central region 46 (or in frame 44). Tether 56 may be fabricated from a flexible material such as rope or from a less flexible material such as plastic. Tether 56 may further be fabricated to have a specific profile that is substantially constantly maintained such as the generally Z-shaped or S-shaped component illustrated in the attached figures.

In accordance with another aspect of the invention, cover 42 further includes a gasket 62. Preferably, gasket 62 is fabricated from a flexible, resilient material, such as foam. Rubber may also be utilized for this purpose. Gasket 62 provides a substantially watertight seal between cover 42 and the rim 11 of wheelbarrow 10 and thus aids in preventing loss of liquid from interior cavity 26.

As best seen in FIGS. 4, 5 and 6, gasket 62 is configured to be complementary to the general shape and size of frame 44 of cover 42. Gasket 62 is also configured to be complementary to the general shape and size of the rim 11 of the wheelbarrow 10. Gasket 62 is a thin strip of material that bounds and defines an aperture 63 which is generally of the same size as the opening to interior cavity 26 defined by rim 11 of wheelbarrow 10. FIGS. 10 and 12 show that gasket 62 is positioned adjacent the interior surface of frame 44 of cover and abuts both first leg 44a and second leg 44b thereof. Preferably, gasket 62 is secured to the interior surface of frame 44 by a suitable means, such as an adhesive, particularly a waterproof adhesive. Gasket 62 thus becomes wedged between frame 44 and rim 11 when cover 42 is positioned on rim 11.

In accordance with yet another aspect of the invention, frame 44 (with gasket 62) simply rests on rim 11; frame 44 is not snap-fitted to or complementarily conformed to rim 11. Cover 42 is therefore not secured to rim 11 by frame 44. Instead, cover 42 is provided with one or more securement assemblies which detachably secure cover 42 with wheelbarrow 10. Preferably, the securement assemblies engage rim 11 but it will be understood that the securement assemblies selected could engage other parts of the wheelbarrow 10.

In accordance with an aspect of the invention, four securement assemblies 64 preferably are provided to secure cover 42 to wheelbarrow 10, most particularly to rim 11. Each securement assembly 64 is movable between an engaged position and a disengaged position. When in the engaged position, the securement assemblies lock the cover 42 to wheelbarrow 10 so that cover 42 cannot be removed from wheelbarrow 10. When securement assemblies 64 are in the disengaged position the cover 42 is not locked to wheelbarrow 10 and may be removed therefrom. A first securement assembly is provided to engage cover 42 with right sidewall 16, a second securement assembly is provided to engage cover 42 with left sidewall 18; a third securement assembly is provided to engage cover 42 with front wall 20; and a fourth securement assembly is provided to engage cover 42 with rear wall 22. It will be understood, however, that fewer or more securement assemblies 64 could be utilized for this purpose and that the securement assemblies 64 could be engaged with cover 42 in any suitable locations.

Preferably, securement assemblies 64 are all substantially identical (although this is not necessary) and are clamping devices. Furthermore, these clamping devices preferably are toggle clamps. FIG. 12 shows that securement assembly 64 includes a mounting bracket 66 which is secured by fasteners 68 to central region 46 of cover 42. (Fasteners 68 are inserted through holes 70 (FIG. 4) in central region 46 and through a flange 72.) One, and preferably two, hook(s) 74 and a handle 76 are secured to bracket 66 by way of a pivot pin 78. Hook 74 is fabricated from wire and where two hooks are utilized, those hooks are spaced a distance apart from each other. This can be seen in FIG. 4. The two hooks may be joined together at the end that engages rim 11. Hook 74 is pivotable to engage an underside or lower surface of rim 11 and to disengage therefrom. When handle 76 is rotated in a first direction indicated by arrow “A” (FIG. 12) hook 74 will disengage from rim 11. When handle 76 is moved in a second direction opposite to arrow “A”, hook 74 will extend around the underside of rim 11 and lock cover 42 to rim 11.

It will be understood that differently configured clamping devices could be utilized on cover 42 as could other types of securement assemblies that do not clamp. Preferably, however, the securement assembly selected is easy to engage and disengage from rim 11 so that securing cover 42 to wheelbarrow and removing cover 42 therefrom is a quick and easy operation.

Cover 42 is used in the following manner. Preferably, when cover 42 is engaged with wheelbarrow 10, a load will not be being carried in the interior 26. However, cover 42 may be engaged with rim 11 whether or not a load is in interior 26. In order to secure cover 42 to rim, cover 42 is lowered onto rim 11 so that the rounded front 42a (FIG. 8) aligns with the section of rim 11 on front wall 20 and flat rear 42b (FIG. 8) aligns with the second of rim on rear wall 22. When gasket 62 contacts rim 11, hooks 74 on securement assemblies 64 are positioned so that they slide under a bottom region of rim 11. The handle 76 on each securement device 64 is moved in the opposite direction of arrow “A” to lock hook 74 in engagement with rim 11. When all of the securement assemblies 64 are in this locked position, cover 42 is firmly secured to wheelbarrow 10 and when pressed against rim 11, gasket 62 is deformed to be complementary in shape to the region of rim 11 with which it is in contact.

Cap 54 is then able to be removed from tubular member 52. (Because of tether 56, cap 54 remains engaged with cover 42.) When cap 54 is unscrewed from tubular member 52, access to interior 26 of wheelbarrow 10 is possible through bore 52a. A pipe 80 is either engaged with tubular member 52 or inserted through bore 52a and liquid wastewater is pumped into interior 26. Preferably, the water level of wastewater 82 (shown in FIG. 13) does not extend past the rim 11 of wheelbarrow 10. (Of course, if cover is placed in engagement with rim 11 after wastewater has already been placed into interior 26 of wheelbarrow 10, it is important for the water level not to be made so high that water will splash out of wheelbarrow 10 before cover 42 is engaged therewith.) Cap 54 is then re-engaged with tubular member 52. The user is then able to grasp handles 28, 30 and wheel wheelbarrow 10 to a remote disposal location. Because of the sealed cover 42 engaged with wheelbarrow 10, none of the wastewater 82 spills out of wheelbarrow 10 and contaminate the ground. The condition of the ground surface over which wheelbarrow 10 is moved is irrelevant because of the sealed cover 42. As shown in FIG. 14, the seal created by gasket 62 and cover 42 is such that the water level of the wastewater 82 may even rise over the rim of the wheelbarrow without spillage. Thus, it is possible to transport more wastewater in a single trip than would normally be possible. Obviously, the same conditions apply if wheelbarrow 10 is used to transport fresh water to a job site. Wheelbarrow 10 is used in this manner if it is desired to transport water to a pump on a cement truck, for example, in order to prime the same. Thus the reference character 82 refers to any type of liquid that is transported within wheelbarrow 10.

When the remote disposal location is reached, cap 54 is removed from cover 42 and another pipe 80 is inserted through bore 52a and into the wastewater 82. A pump engaged with the opposite end (not shown) of pipe 80 may be activated to pump water from the interior 26. When all of the wastewater is removed, pipe 80 is removed and the wheelbarrow 10 may be wheeled back to the original location to pick up another load. Because cap 54 is tethered to cover 42, cap 54 does not need to be engaged with tubular member 52 for the return journey. Alternatively, if it is desired, the entire cover 42 may be removed from rim 11 by reversing the steps of engagement described above and the wheelbarrow 10 may then be tipped to cause the wastewater to flow over the upper edge 20a of front wall 20. When all of the water is drained from wheelbarrow 10 then the cover is re-engaged therewith and locked in place.

It will also be understood that if fresh water is moved using wheelbarrow 10, a pipe 80 hooked to a pump can be utilized to pump the fresh water from the interior 26 of wheelbarrow 10.

Instead of the securement assemblies 64 being mounted on cover 42, the assemblies may be mounted onto the wheelbarrow peripheral wall and include hooks or other components that selectively extend upwardly to engage and secure cover 42 to wheelbarrow 10.

It has been disclosed herein that all of the securement assemblies 64 are active locking devices that lock cover 42 to wheelbarrow 10. It is possible that some of the securement assemblies 64 may be passive devices which simply engage the rim 11 to latch the cover thereto but not to lock it thereto. So, for example, some of the securement devices may simply be hooks that are slipped around the rim but these devices lack the handle that can be maneuvered to clamp that hook in place. At least one or two of the other securement assemblies 64 will need to be active locking devices that will secure the cover to the rim.

It will be understood that while central region 46 has been disclosed herein as being a truncated-dome shaped member, it may, instead, be flat and planar or any other desired configuration.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the invention are an example and the invention is not limited to the exact details shown or described.

1. A cover for a wheelbarrow, where the wheelbarrow has a peripheral wall which bounds and defines an interior cavity for carrying a load, and wherein an upper edge of the peripheral wall forms a rim; and wherein said cover comprises:
a central region having an interior surface and an exterior surface;
a frame circumscribing the central region;
a gasket provided on an interior surface of the frame; said gasket being adapted to be positioned adjacent the rim of the wheelbarrow when the cover is used to close off access to the interior cavity of the wheelbarrow.

2. The cover as defined in claim 1, further comprising:
a securement assembly adapted to secure the cover to the wheelbarrow; wherein the securement assembly is movable between an engaged position and a disengaged position; and when in the engaged position the securement assembly locks the cover to the wheelbarrow; and when the securement assembly is in the disengaged position, the cover is not locked to the wheelbarrow.

3. The cover as defined in claim 2, wherein the securement assembly is a clamping assembly adapted to engage the rim of the wheelbarrow.

4. The cover as defined in claim 3, wherein the clamping assembly is a toggle clamp.

5. The cover as defined in claim 4, wherein the toggle clamp includes a hook and the hook is adapted to be selectively engageable around a region of the rim of the wheelbarrow.

6. The cover as defined in claim 5, wherein the hook is fabricated from wire.

7. The cover as defined in claim 1, wherein the gasket is flexible.

8. The cover as defined in claim 1, wherein the gasket is fabricated from foam or rubber.

9. The cover as defined in claim 1, further comprising:
a hole defined in the central region of the cover;
a tubular member engaged in the hole and defining a bore therein; and
a cap detachably engaged with the tubular member to selectively block access to the bore.

10. The cover as defined in claim 9, further comprising a tether extending between a portion of the cover and the cap.

11. The cover as defined in claim 1, wherein the central region is generally C-shaped in cross-section.

12. The cover as defined in claim 1, wherein the central region has a truncated-dome shape.

13. The cover as defined in claim 1, wherein the frame is substantially L-shaped with a first leg of the frame extending outwardly from the central region at an angle; and a second leg of the frame extending downwardly from the first leg and substantially at right angles to the first leg.

14. The cover as defined in claim 1, wherein the frame is substantially continuous and unbroken around the entire central region.

15. A wheelbarrow and cover in combination; wherein the wheelbarrow has a peripheral wall which bounds and defines an interior cavity for carrying a load, and an upper edge of the peripheral wall forms a rim; and
the cover is selectively engageable with the wheelbarrow to prevent access to the interior cavity; wherein said cover comprises:
a central region having an interior surface and an exterior surface;
a frame circumscribing the central region;
a gasket provided on an interior surface of the frame; said gasket being positioned adjacent the rim of the wheelbarrow when the cover is selectively engaged with the wheelbarrow.

16. The combination as defined in claim 15, wherein the frame is substantially continuous and circumscribes the entire rim of the wheelbarrow.

17. The combination as defined in claim 15, wherein the gasket is in contact with the entire rim of the wheelbarrow.

18. The combination as defined in claim 15, wherein the cover is sealed to the rim by the gasket.

19. The combination as defined in claim 15, wherein substantially the entire cover extends upwardly away from the rim of the wheelbarrow.

20. The combination as defined in claim 15, further comprising:
a securement assembly adapted to secure the cover to the wheelbarrow; wherein the securement assembly is movable between an engaged position and a disengaged position; and when in the engaged position the securement assembly locks the cover to the wheelbarrow; and when the securement assembly is in the disengaged position, the cover is not locked to the wheelbarrow.

21. The combination as defined in claim 15, further comprising:
a hole defined in the central region of the cover;
a tubular member engaged in the hole and defining a bore therein; and
a cap detachably engaged with the tubular member to selectively block access to the bore.

22. The combination as defined in claim 21, further comprising a tether extending between a portion of the cover and the cap.
